(19) United States
(12) Patent Application Publication
(10) Pub. No.: US 2006/0187650 A1
(43) Pub. Date: Aug. 24, 2006

(54) Direct lit backlight with light recycling and source polarizers

(75) Inventors: Kenneth A. Epstein, St. Paul, MN (US); Mark B. O'Neill, Stillwater, MN (US)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 11/064,685

(22) Filed: Feb. 24, 2005

(51) Int. Cl. F21V 9/14

(52) U.S. Cl. 362/19

(57) ABSTRACT

Direct lit backlights and associated methods are disclosed in which typically an array of light sources is disposed between a back reflector and a front reflective polarizer. Source polarizers are provided to cover the light sources. Light that passes through the source polarizer towards the front reflective polarizer is partially transmitted and partially reflected by the front reflective polarizer. The partial transmission and reflection can be balanced to enhance illumination uniformity over the output face of the backlight. Direct lit backlights having arrays of polarized light sources are also disclosed, including backlights in which the light sources use LED light sources, and backlights in which the polarized light sources are substantially aligned with each other.

### FIELD OF THE INVENTION

The present invention relates to backlights, such as those used in liquid crystal display (LCD) devices and similar displays, as well as to methods of making backlights.

### BACKGROUND

Recent years have seen tremendous growth in the number and variety of display devices available to the public. Computers (whether desktop, laptop, or notebook), personal digital assistants (PDAs), mobile phones, and thin LCD TVs are but a few examples. Although some of these devices can use ordinary ambient light to view the display, most include a backlight to make the display visible.

Many such backlights fall into the categories of “edge lit” or “direct lit”. These categories differ in the placement of the light sources relative to the output face of the backlight, which output face defines the viewable area of the display device. In edge lit backlights, a light source is disposed along an outer border of the backlight construction, outside the area or zone corresponding to the output face. The light source typically emits light into a light guide, which has length and width dimensions on the order of the output face and from which light is extracted to illuminate the output face. In direct lit backlights, an array of light sources is disposed directly behind the output face, and a diffuser is placed in front of the light sources to provide a more uniform light output. Some direct lit backlights also incorporate an edge-mounted light, and are thus capable of both direct lit and edge lit operation.

### BRIEF SUMMARY

The present application discloses, inter alia, direct lit backlights and associated methods in which at least one light source, and typically a plurality or array of light sources, is disposed between a back reflector and a front reflective polarizer. The front reflective polarizer has a size, e.g. a length and width, commensurate with that of an output face of the backlight. In some cases the front reflective polarizer may itself be the output face of the backlight; in other cases one or more other optical films, such as a diffusing film, may be mounted in front of the front reflective polarizer and form the output face of the backlight.

A source polarizer is provided that is smaller than the output face but big enough to at least partially cover the light source. The front reflective polarizer and the source polarizer are arranged or otherwise configured such that light from the light source that passes through the source polarizer towards the front reflective polarizer is neither completely transmitted nor completely reflected by the front reflective polarizer. Instead, it is partially transmitted and partially reflected by the front reflective polarizer. In the case of high quality, high extinction ratio (low leakage) linear polarizers, this means that the polarizers are partially crossed, that the pass axes of the respective polarizers are neither precisely parallel nor precisely perpendicular to each other. Rather, they are oblique. The partial transmission and reflection can be balanced or otherwise selected to minimize or at least reduce variations in brightness over the output face of the backlight. In the case of linear polarizers, such balance or selection can be achieved by adjustment of the relative angle between the pass axes of the polarizers.

The backlights can support light recycling between the front reflective polarizer and the back reflector. Preferably, the back reflector is both highly reflective and polarization converting. In that regard, the back reflector preferably converts incident light of one polarization state at least partially into reflected light of an orthogonal polarization state.

Direct lit backlights are disclosed in which an array of polarized light sources is disposed between a front reflective polarizer and a back reflector. The polarized light sources may comprise conventional light sources in combination with source polarizers sized to at least partially cover the light sources. The polarized light sources may also comprise compact LED-based sources that incorporate a polarizing film or device. Light from a polarized light source is partially reflected and partially transmitted by the front reflective polarizer. Preferably, the back reflector is both highly reflective and polarization converting.

The polarizing films and devices need not be ideal polarizers, insofar as they may be selected to have a substantial amount of leakage of the normally rejected (absorbed or reflected) polarization state.

These and other aspects of the present application will be apparent from the detailed description below. In no event, however, should the above summaries be construed as limitations on the claimed subject matter, which subject matter is defined solely by the attached claims, as may be amended during prosecution.

### BRIEF DESCRIPTION OF THE DRAWINGS

Throughout the specification, reference is made to the appended drawings, where like reference numerals designate like elements, and wherein:

FIG. 1 is a perspective exploded view of a direct lit backlight in combination with a liquid crystal display;

FIG. 2 is a schematic cross-sectional view of a direct lit backlight;

FIG. 3 is a plan view of the backlight of FIG. 2;

FIG. 4 is a plan view of an alternative backlight that utilizes compact light sources such as LEDs;

FIGS. 5a-c are schematic cross-sectional views of compact polarized light sources useable in the backlight of FIG. 4; and

FIG. 6 is an idealized graph showing brightness versus position on at least a portion of the output face of a backlight, for different relative orientations of the polarizers.

### DETAILED DESCRIPTION OF THE ILLUSTRATIVE EMBODIMENTS

Unless otherwise indicated, all numbers expressing feature sizes, amounts, and physical properties used in the specification and claims are to be understood as being modified by the term “about.” Accordingly, unless indicated to the contrary, the numerical parameters set forth in the present specification and claims are approximations that can vary depending upon the desired properties sought to be obtained by those skilled in the art utilizing the teachings disclosed herein.

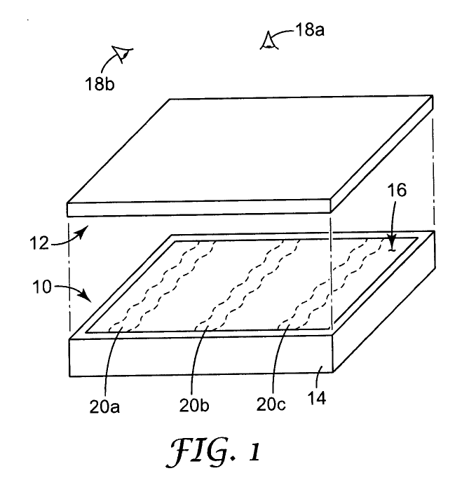

In FIG. 1, we see in perspective exploded view a direct lit backlight 10 in combination with a display panel 12, such as a liquid crystal display (LCD) panel. Both backlight 10 and display panel 12 are shown in a simplified box-like form, but the reader will understand that each contains additional detail. Backlight 10 includes a frame 14 and an extended output face 16. In operation, the entire output face 16 is illuminated by light source(s) disposed within the frame 14 behind the output face. When illuminated, the backlight 10 makes visible for a variety of observers 18a, 18b an image or graphic provided by display panel 12. The image or graphic is produced by an array of typically thousands or millions of individual picture elements (pixels), which array substantially fills the lateral extent (length and width) of the display panel 12. In most embodiments, the backlight 14 emits white light and the pixel array is organized in groups of multicolored pixels (such as red/green/blue (RGB) pixels, red/green/blue/white (RGBW) pixels, ant the like) so that the displayed image is polychromatic. In some cases, however, it may be desirable to provide a monochrome display. In those cases the backlight 14 can include filters or specific sources that emit predominantly in one visible wavelength or color.

Backlight 10 in FIG. 1 is depicted as including three elongated light sources disposed behind the output face 16 as indicated in the figure by source zones 20a, 20b, 20c. Areas of the output face 16 between or otherwise outside of the source zones are referred to herein as gap zones. The output face 16 can therefore be considered as being made up of a complementary set of source zones and gap zones. The existence of source zones and gap zones are a consequence of the fact that the light sources, even if they are extended, are both individually and collectively much smaller in projected area (plan view) than the output face of the backlight. In most embodiments, in order to provide optimum image quality from the display, it is desirable to configure the backlight 10 such that the brightness at the output face 16 is as uniform as possible. In those cases, the brightness in the source zones should be substantially the same as the brightness in the gap zones.

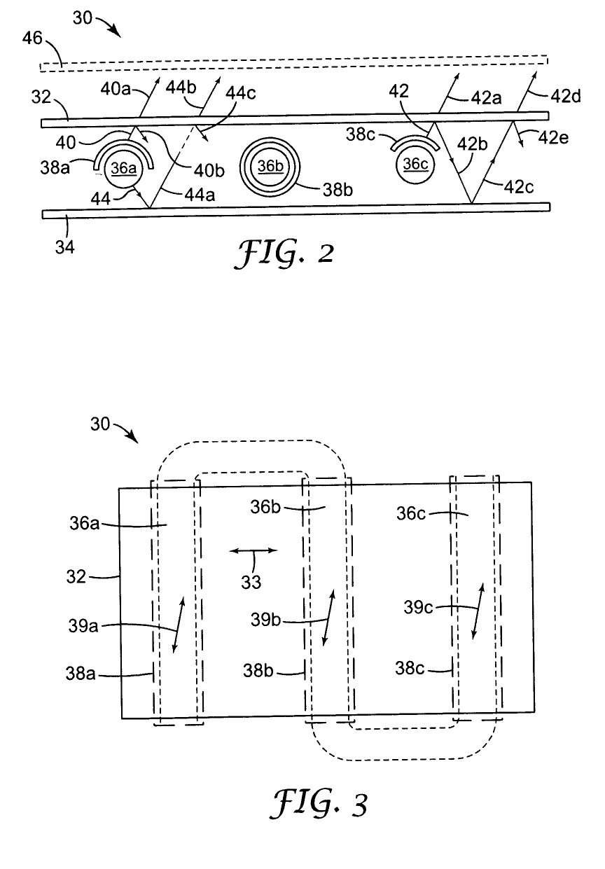

FIG. 2 is a schematic sectional view of a direct lit backlight 30 capable of achieving such uniformity in an efficient light-recycling design. Backlight 30 includes a front reflective polarizer 32, a back reflector 34, and an array of light sources 36a, 36b, 36c (collectively, 36). Reflective polarizer 32 and back reflector 34 form a light recycling cavity, within which light can undergo successive reflections. The reflective polarizer transmits light of a first polarization state, and reflects light of a second polarization state orthogonal to the first polarization state. “Orthogonal” in this regard simply means a state that is complementary to the other state, and is not limited to a 90 degree linear geometry. The reflective polarizer can be or comprise, for example, any of the dual brightness enhancement film (DBEF) products or any of the diffusely reflective polarizing film (DRPF) products available from 3M Company under the Vikuiti brand, or one or more cholesteric polarizing films. Wire grid polarizers, such as those described in U.S. Pat. No. 6,243,199 (Hansen et al.) and US Patent Publication 2003/0227678 (Lines et al.), and MacNeille polarizers, such as those described in U.S. Pat. No. 5,559,634 (Weber), are also suitable reflective polarizers. Uniaxially oriented specularly reflective multilayer optical polarizing films are described in U.S. Pat. No. 5,882,774 (Jonza et al.), U.S. Pat. No. 5,612,820 (Schrenk et al.), and WO 02/096621 A2 (Merrill et al.). Diffusely reflective polarizers having a continuous phase/disperse phase construction are described, for example, in U.S. Pat. No. 5,825,543 (Ouderkirk et al.). In some cases, such as with 3M™ Vikuiti™ Dual Brightness Enhancement Film-Diffuse (BEF-D) available from 3M Company, the diffusely reflective polarizer also transmits light diffusely. Known cholesteric reflective polarizers are another type of reflective polarizer suitable for use in the disclosed backlight embodiments. In cases where the display panel 12 to be used with the backlight 30 includes its own rear polarizer for placement proximate the backlight, such as with most LCD displays, it is desirable to configure front reflective polarizer 32 to be in alignment with the display panel rear polarizer, or vice versa, for maximum efficiency and illumination. The rear polarizer of an LCD display panel is usually an absorbing polarizer, and usually is positioned on one side of a pixilated liquid crystal device, on the other side of which is a display panel front polarizer.

For increased illumination and efficiency, it is also advantageous that back reflector 34 not only have overall high reflectivity and low absorption but also be of the type that at least partially converts the polarization of incident light upon reflection. That is, if light of one polarization state is incident on the back reflector, then at least a portion of the reflected light is polarized in another polarization state orthogonal to the first state.

Many diffuse reflectors have this polarization-converting feature. One class of suitable diffuse reflectors are those used for example as white standards for various light measuring test instruments, made from white inorganic compounds such as barium sulfate or magnesium oxide in the form of pressed cake or ceramic tile, although these tend to be expensive, stiff, and brittle. Other suitable polarization-converting diffuse reflectors are (1) microvoided particle-filled articles that depend on a difference in index of refraction of the particles, the surrounding matrix, and optional air-filled voids created from stretching and (2) microporous materials made from a sintered polytetrafluoroethylene suspension or the like. Another useful technology for producing microporous polarization-converting diffusely reflective films is thermally induced phase separation (TIPS). This technology has been employed in the preparation of microporous materials wherein thermoplastic polymer and a diluent are separated by a liquid-liquid phase separation, as described for example in U.S. Pat. No. 4,247,498 (Castro) and U.S. Pat. No. 4,867,881 (Kinzer). A suitable solid-liquid phase separation process is described in U.S. Pat. No. 4,539,256 (Shipman). The use of nucleating agents incorporated in the microporous material is also described as an improvement in the solid-liquid phase separation method, U.S. Pat. No. 4,726,989 (Mrozinski). Further suitable diffusely reflective polarization-converting articles and films are disclosed in U.S. Pat. No. 5,976,686 (Kaytor et al.).

In some embodiments the back reflector 34 can comprise a very high reflectivity specular reflector, such as multilayer polymeric Enhanced Specular Reflector (ESR) film available from 3M Company under the Vikuiti brand, optionally in combination with a quarter wave film or other optically retarding film. Alanod™ brand anodized aluminum sheeting and the like are another example of a highly reflective specular material. As an alternative to constructions discussed above, polarization conversion can also be achieved with a combination of a high reflectivity specular reflector and a volume diffusing material disposed between the back reflector and the front reflective polarizer, which combination is considered for purposes of this application to be a polarization-converting back reflector.

When back reflector 34 is of the polarization-converting type, light that is initially reflected by reflective polarizer 32, because its polarization state is not transmitted by the polarizer, can be at least partially converted after reflection by the back reflector 34 to light whose polarization state will now pass through the reflective polarizer, thus contributing to overall backlight brightness and efficiency.

Disposed within the cavity between the reflective polarizer 32 and the back reflector 34 are sources 36. From the standpoint of the viewer, and in plan view, they are disposed behind the reflective polarizer 32. The outer emitting surface of the light sources is shown to have a substantially circular cross-section, as is the case for conventional fluorescent tubes or bulbs, but other cross-sectional shapes can also be used. The number of sources, the spacing between them, and their placement relative to other components of the backlight can be selected as desired depending on design criteria such as power budget, overall brightness, thermal considerations, size constraints, and so forth.

Significantly, backlight 30 also includes source polarizers 38a-c that cover sources 36a-c respectively. In the case of tubular light sources, the source polarizers can be in the form of a continuous sleeve as shown at 38b, which completely surrounds the source, or they can only partially surround the source as shown at 38a or 38c. More generally, where the source is one that emits light both towards the front reflective polarizer 32 and towards the back reflector 34, the source polarizer can be configured such that it intercepts at least the former and optionally the latter emitted light. Multiple source polarizers in a given backlight can be substantially identical, e.g. where each source polarizer is in the form of a continuous sleeve that completely surrounds its respective light source, or where each source polarizer covers only a portion of its respective light source. Alternatively, the source polarizers within a backlight can be configured differently, e.g. as shown in FIG. 2 where source polarizers 38a-c cover the respective light sources 36a-c in differing amounts.

For ease of illustration, FIG. 2 shows a small gap between the light sources and their respective source polarizers. The source polarizers can alternatively be directly laminated or otherwise applied to a surface of the light source, e.g. by an adhesive such as a pressure sensitive adhesive (PSA) or a UV-curable adhesive, or even by coating the polarizer to the source such as in the case of cholesteric polarizers, to reduce or eliminate intervening air gaps and associated losses. In that regard, losses may also be reduced and efficiencies increased by fabricating the source polarizers using reflective polarizing films rather than absorptive polarizing films. One reason for this is that, to the extent light recycling occurs in the backlight, reflective polarizing films reduce absorptive losses within the cavity, relative to absorptive polarizing films. Another reason is that if the light source itself includes a reflective element or structure that is at least partially polarization converting, then using a reflective polarizer as the source polarizer can produce light recycling within the light source, thus increasing the polarized brightness of the (light source)-(source polarizer) combination. The layer of phosphor in a fluorescent lamp, for example, can function as a polarization converting reflective element. In some embodiments, however, absorptive polarizing films are entirely satisfactory for use as the source polarizers.

FIG. 2 also shows several representative light rays. Rays 40 and 42 are the portions of rays emitted by sources 36a, 36c respectively that pass through the respective source polarizers 38a, 38c. Those rays are shown directed towards portions of the front reflective polarizer 32 proximate the respective sources, i.e., towards source zones of the output surface of the backlight. Rays 40 and 42 have polarization states determined by the configuration of the respective source polarizers 38a, 38c. Upon striking the front reflective polarizer 32, part of these rays are transmitted as rays 40a, 42a, and part are reflected as rays 40b, 42b. Transmitted rays 40a, 42a have polarization states determined by the configuration of front reflective polarizer 32. Reflected rays 40b, 42b also have polarization states determined by the configuration of front reflective polarizer 32, but the polarization states of reflected rays 40b, 42b are orthogonal to the polarization states of transmitted rays 40a, 42a. Ray 42b is shown proceeding further to back reflector 34, from which it reflects as ray 42c. By partially converting the polarization state of ray 42b into a state that can be passed by the front polarizer, that portion of the reflected ray 42c is transmitted as ray 42d, while the remaining portion is reflected as ray 42e. The figure also shows ray 44, emitted by source 36a in an initial direction towards the back reflector 34. Ray 44 may be polarized in a given polarization state or it may be unpolarized. It is reflected by back reflector 34 into a ray 44a, and then partially reflected and partially transmitted by front reflective polarizer 32 as shown with rays 44b, 44c. Note that if front reflective polarizer 32 and back reflector 34 are diffusely reflective, then at least the reflected rays 40b, 42b, 42c, 42e, 44a, 44c, which are depicted as single rays with defined directions, will be light propagating over a range or distribution of directions depending on how diffusely reflective the respective components are.

Depending on the application it may be desirable in some embodiments to include in the direct lit backlight between the front reflective polarizer and the back reflector, in addition to one or a plurality of light sources that are covered with respective source polarizers, one or more other light sources that are not so covered. Such uncovered light source(s) might for example be placed close to the perimeter of the output face of the backlight to compensate for edge effects.

Backlight 30 can also include other optical films, represented by generic film 46. Film 46 can comprise a diffusely transmittingfilm, such as coated, embossed, particle-loaded, and/or microvoided films as discussed above (??). Keiwa brand diffusing film, type PC02W, is one example. Preferably the diffusely transmitting film is low in retardation to avoid undesirable color and luminance effects in LCD display panels. Film 46 can also or alternatively comprise a prismatic brightness enhancing film such as the Vikuiti brand line of brightness enhancing prismatic films sold by 3M Company. Preferably, film 46 is disposed on or close to the front reflective polarizer 32 to reduce the overall size of the backlight 30.

Turning now to FIG. 3, we see there a plan view of the backlight 30. In this view, the front reflective polarizer 32 and the source polarizers 38a-c are shown as being linear polarizers, having pass axes 33 and 39a-c respectively. The polarizing film used for the source polarizers has been shifted in orientation so that each of the axes 39a-c is partially crossed, i.e., disposed at an oblique angle, with respect to the pass axis 33 of the front reflective polarizer 32. Hence, light transmitted by the source polarizers 38a-c is partially transmitted and partially reflected by the front reflective polarizer. Although the axes 39a-c are shown as being parallel to each other or otherwise in the same orientation, this need not be the case. The pass axis or orientation of each source polarizer can if desired be individually tailored independent of the other source polarizers. Tailoring of the orientation can be accomplished by pivoting or rotating the source polarizer whether by itself or in combination with its associated light source. Such tailoring may be used in some cases to introduce a controlled amount of variability in polarization orientation or a random or repeating pattern of relative misalignment in an array of source polarizers in order to adjust the brightness distribution of the output face of the backlight. Where the light sources have an elongated shape such as with most cold cathode fluorescent lamps (CCFLs), the pass axis of the respective source polarizer can be aligned with the major or minor axis of the source, or can be misaligned therewith as shown in the figure. The light sources can be individual discrete units, or portions of a larger serpentine unit as depicted in FIG. 3.

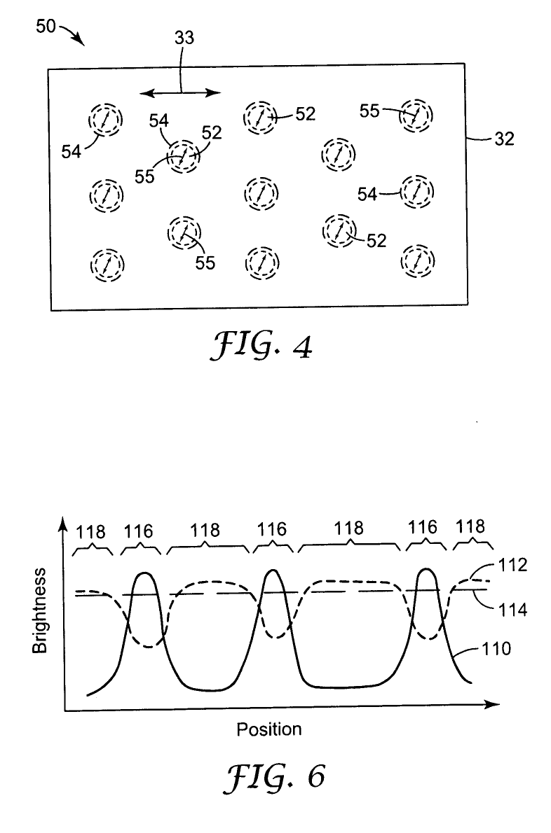

FIG. 4 shows a plan view of an alternative backlight 50 similar to those shown and described in connection with FIGS. 1-3 except that the elongated sources have been replaced with an array of compact or small area sources 52. These sources may be, for example, LED sources. A source polarizer 54 covers each source in the array. In FIG. 4, source polarizers 54 and the front reflective polarizer 32 are depicted as linear polarizers, with pass axes 55 and 33 respectively. The pass axes 55 are shown partially crossed with respect to pass axis 33, but they can also be completely crossed depending on polarizer leakage and the desired brightness profile of the backlight. The pass axes 55 of all of the source polarizers can, but need not be, parallel or otherwise aligned, since they can also be individually tailored as discussed above. The source polarizers 54 can be absorbing polarizers or, preferably, reflective polarizers, and need not be linear polarizers.

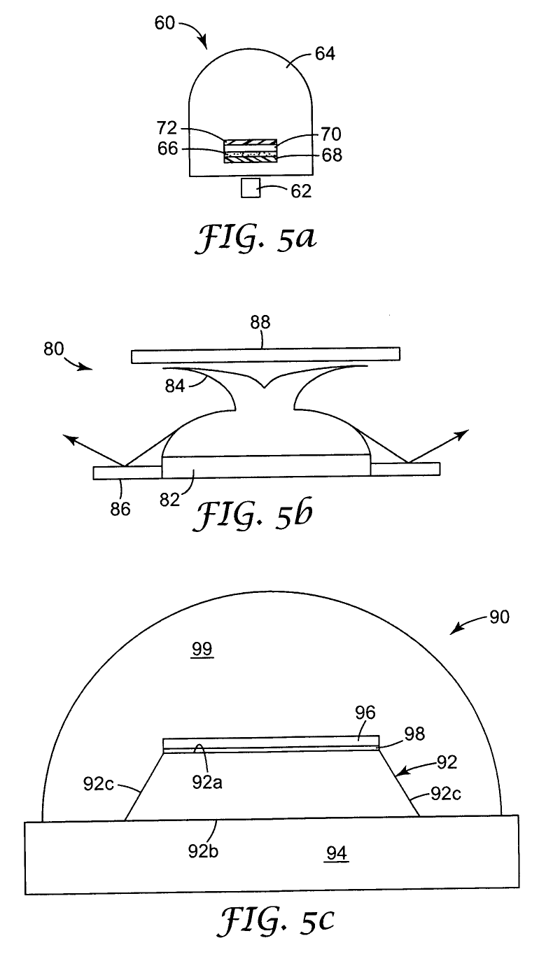

FIGS. 5a-c depict various LED-based compact source polarizer/source combinations useable with backlight embodiments such as that depicted in FIG. 4. In some of these combinations the source polarizer can be incorporated into a unitary LED package. In that regard—both with respect to these LED embodiments as well as embodiments that use other types of light sources—the combination of a source and a source polarizer is sometimes referred to herein simply as a polarized light source.

In FIG. 5a, a phosphor-based LED construction 60 is shown in schematic sectional view. The construction 60 includes an LED 62 light source, such as an LED die, that emits excitation light at an excitation light wavelength, typically in the blue or UV region of the spectrum. The LED is shown adjacent to optically transparent material 64, but the transparent material 64 can if desired be extended downward to include and embed the LED 62. The construction also includes a layer of phosphor material 66, shown disposed within the optically transparent material 64, and positioned to receive the light emitted by LED 64. The phosphor material can be coated onto a short pass reflector 68, which is shown positioned between the phosphor and the LED 62. The short pass reflector 68 transmits short wavelength excitation light from the LED and reflects the relatively longer wavelength light emitted by the phosphor upon exication. On the other side of the phosphor material layer 66 is a long pass reflector 70, which transmits the long wavelength light emitted by the phosphor, but reflects any short wavelength excitation light from the LED that traverses the phosphor layer. Also included in the sandwich construction is a reflective polarizer 72. Reflective polarizer 72 is disposed within the optically transparent material 64 and adjacent the layer of phosphor material 60 with long pass reflector 70 disposed therebetween as shown. The reflective polarizer 72 is shown having a planar shape, but can also have a non-planar shape. In any case reflective polarizer 72 covers the LED 62. For further details on combination 60, and on additional polarized LED packages, the reader is referred to U.S. Patent Application Publication US 2004/0150997 A1 (Ouderkirk et al.).

FIG. 5b shows another suitable source 80. This source includes an LED 82 and a specially designed side-emitting lens 84 mounted atop the LED. The side-emitting lens 84, through a combination of reflection and refraction, helps direct light emitted by the LED into sideways directions as shown, all the way around the source (360 degrees) due to the cylindrical symmetry of lens 84. For details on the lens 84/LED 82 combination, the reader is referred to U.S. Patent Application Publication US 2005/0001537 A1 (West et al.). Source 80 can also include a specular ring reflector 86. Reflector 86 can comprise any highly reflective material or film as discussed above. Finally, source 80 includes a source polarizer 88 in the shape of a disk, which can be mounted atop lens 84. Polarizer 88 thus has the effect of covering, at least partially, the LED 82. Light from the LED transmitted through the top of lens 84 is polarized by polarizer 88.

FIG. 5c shows yet another compact LED-based polarized source 90. Source 90 includes an LED die 92 attached to a header or mount 94. LED die 92 has a front emitting surface 92a, a bottom surface 92b, and side surfaces 92c. The side surfaces 92c are shown to be angled, but this is not necessary and other side surface configurations are also contemplated. Source 90 also includes a reflective polarizer 96, which transmits a first polarization state of light to the outside environment and preferentially reflects an orthogonal second polarization state of light back into the LED die 92. In the embodiment of FIG. 5c, a polarization converting layer in the form of a quarter-wave plate 98 is provided between the reflective polarizer and LED emitting surface 32a. Also, a transparent optical element 99 such as a molded resin surrounds and encapsulates the LED die and other layers atop the mount 94. For further details on source 90, and on additional polarized LED packages, the reader is referred to commonly assigned U.S. patent application Ser. No. 10/977582, “Polarized LED”, filed Oct. 29, 2004.

FIG. 6 is an idealized plot of brightness of the backlight along a path that extends across all or a portion of the backlight's output surface, e.g., across the surface of front reflective polarizer 32 or of film 46 if present. The path is selected to include zones of the output surface immediately above the light sources, i.e., source zones 116, as well as zones of the output surface not immediately above any light source, i.e., gap zones 118. By tailoring the degree to which the source polarizers are partially crossed relative to the front reflective polarizer, the brightness pattern at the output surface can be modified over a wide range.

For curve 110, the source polarizers are all nearly aligned with the front reflective polarizer, such that light transmitted through the source polarizers towards the front of the display is predominantly transmitted through the front reflective polarizer and reflected to only a small degree. Thus, the source zones 116 become relative bright spots between relatively dark gap zones 118.

For curve 112, one or both of the front reflective polarizer or the source polarizers have been adjusted or otherwise modified to the point of being almost completely crossed. In that case, light transmitted through the source polarizers towards the front of the display is predominantly reflected off of the front reflective polarizer, and transmitted to only a small degree. Thus, the source zones 116 become relative dark spots between relatively bright gap zones 118. In the case of linear polarizers, adjustment between the front reflective polarizer and any given source polarizer can be achieved by simply rotating either polarizer relative to the other.

For curve 114, one or both of the front reflective polarizer or the source polarizers have been adjusted or otherwise modified so that they are partially crossed in a balanced amount. In that special case, light transmitted through the source polarizers towards the front of the display is reflected from and transmitted by the front reflective polarizer in amounts that cause the source zones 116 to have a brightness that substantially matches that of the gap zones 118. In this way, highly uniform illumination in a high brightness direct lit backlight can be achieved. Since perfect uniformity is rarely achievable for real systems, the relative orientation of the polarizers can be adjusted to minimize brightness variability over all or some portion of the output surface of the backlight. Note that a similar high uniformity direct lit backlight can be achieved by controlling the amount of leakage of the normally blocked polarization state in the front reflective polarizer, the source polarizer, or both. The degree to which the source polarizer and the front reflective polarizer are crossed or misaligned to achieve brightness uniformity is thus a function of the amount of leakage of the polarizers.

The disclosed backlights can also comprise retardation films such as quarter wave films, whether between the source polarizer and the source or applied to the back reflector, to facilitate polarization conversion of recycled light and improve overall efficiency of the backlight. Quarter wave films can also be used in combination with left- or right-handed circular reflective polarizers, such as cholesteric reflective polarizers. Alternatively, circular polarizers can be used without any retardation films. In some embodiments, two or more source polarizers can be different portions of a larger unitary polarizing film. For example, in an array of compact LED sources, a unitary strip of polarizing film can be positioned to cover a row of densely packed LED sources.

As mentioned above, the source polarizer, the front reflective polarizer, or both can be deliberately selected to have a substantial amount of leakage of the normally rejected (absorbed or reflected) polarization state. Thus, light transmitted by the source polarizer may comprise not only a first polarization state but also, to a lesser degree, a second orthogonal polarization state. Similarly, light transmitted by the front reflective polarizer may comprise not only a first polarization state but also, to a lesser degree, a second (orthogonal) polarization state. The bodies are however still considered to be polarizers because they predominantly transmit one polarization state and predominantly block (absorb or reflect) the orthogonal state. Use of such leaky polarizers can help to reduce the modulation in brightness between completely crossed and completely aligned polarizers, and can help soften transitions in brightness from source zones to gap zones.

Various modifications and alterations of this invention will be apparent to those skilled in the art without departing from the scope and spirit of this invention, and it should be understood that this invention is not limited to the illustrative embodiments set forth herein. All U.S. patents, patent application publications, and other patent and non-patent documents referred to herein are incorporated by reference, to the extent they are not inconsistent with the foregoing disclosure.

What is claimed is:

1. A direct lit backlight having an output face, comprising:
a front reflective polarizer;
a back reflector;
a light source disposed between the reflective polarizer and the back reflector; and
a source polarizer at least partially covering the light source;
wherein light transmitted through the source polarizer is partially transmitted and partially reflected by the front reflective polarizer.

2. The backlight of claim 1, wherein the light source is selected from the group of a fluorescent lamp and a light emitting diode (LED).

3. The backlight of claim 1, wherein the source polarizer comprises a reflective polarizer.

4. The backlight of claim 1, wherein the light source is one of a plurality of light sources disposed between the front reflective polarizer and the back reflector.

5. The backlight of claim 4, wherein the source polarizer is one of a plurality of source polarizers, each source polarizer at least partially covering a corresponding one of the light sources.

6. The backlight of claim 5, wherein at least some of the plurality of source polarizers are partially crossed with the front reflective polarizer.

7. The backlight of claim 1, wherein the back reflector is polarization converting.

8. The backlight of claim 1, wherein the front reflective polarizer is selected from the group of specularly reflective polarizers and diffusely reflective polarizers.

9. The backlight of claim 1, further comprising a diffusely transmissive layer disposed atop the front reflective polarizer.

10. The backlight of claim 1 in combination with a display panel.

11. The backlight of claim 1, wherein the front reflective polarizer has lateral dimensions commensurate with the output face, and the source polarizer is smaller in plan view area than the output face.

12. A direct lit backlight, comprising:
a front reflective polarizer;
a back reflector; and
an array of polarized light sources disposed between the reflective polarizer and the back reflector.

13. The backlight of claim 12, wherein the light sources are arranged such that light emitted by the light sources is partially transmitted and partially reflected by the front reflective polarizer.

14. The backlight of claim 12, wherein the back reflector is polarization converting.

15. The backlight of claim 12, wherein the light sources comprise LEDs.

16. The backlight of claim 12, wherein the light sources have polarization orientations that are substantially the same.

17. A method of making a direct lit backlight, comprising:
providing a front reflective polarizer and a polarization-converting back reflector;
positioning a polarized light source between the front reflective polarizer and the back reflector; and
orienting the polarized light source relative to the front reflective polarizer to achieve a desired illumination across the backlight.

18. The method of claim 17, the orienting step includes orienting the polarized light source such that light emitted by the polarized light source is partially transmitted and partially reflected by the front reflective polarizer.

19. The method of claim 17, wherein the backlight has an output face, and wherein the orienting step is carried out to enhance brightness uniformity at the output face.

20. The method of claim 17, wherein the orienting step includes rotating at least one of the front reflective polarizer and the polarized light source.

21. The method of claim 17, wherein the polarized light source in the providing step is one of a plurality of polarized light sources provided between the front reflective polarizer and the polarization-converting back reflector.

22. The method of claim 21, wherein the tailoring step includes rotating at least some of the polarized light sources.
